(19) United States
(12) Patent Application Publication
(10) Pub. No.: US 2024/0269891 A1
(43) Pub. Date: Aug. 15, 2024

(54) Intelligent Cutting Machine For Cutting Wall

(71) Applicant: EGUN CO., LTD., Gwangju-si (KR)

(72) Inventors: Sung Jun LEE, Gwangju-si (KR); Chae Mun LEE, Seongnam-si (KR)

(21) Appl. No.: 18/267,063

(22) PCT Filed: Dec. 12, 2021
(86) PCT No.: PCT/KR2021/018820

§ 371 Date: May 2, 2024

(30) Foreign Application Priority Data
Dec. 14, 2020 (KR) 10-2020-0174044

(51) Int. Cl. B28D 1/24

(52) U.S. Cl. CPC B28D 1/24

(57) ABSTRACT

A cutting machine may comprise: a main frame; a first front wheel and a second front wheel, respectively, of the front of the main frame; one rear wheel; a cutting frame having one side fixed near the front of the main frame; a cutting shaft positioned near the other side of the cutting frame; a cutting blade fitted into one side of the cutting shaft to cut a structure; a rotating motor fixed to one side of the cutting frame to drive rotation of the cutting blade; an auxiliary frame hinge-coupled to the cutting frame; a front wheel shaft connected between the main frame and the first front wheel or the second front wheel; and a height-adjusting part, which is connected to the front wheel shaft to adjust the angle of the front wheel shaft so that the height of one side of the main frame can be adjusted.

### TECHNICAL FIELD

The present invention relates to a cutting machine, and more particularly to an intelligent cutting machine for cutting concrete or a wall of a structure on a road, etc.

### BACKGROUND ART

FIG. 1 is a view showing a conventional wall cutting machine.

Referring to FIG. 1, the conventional wall cutting machine (wall saw) adopts a system in which the wall cutting machine cuts a wall through rotation of a cutting blade while moving on a fixed or set path along a fixedly installed guide rail. Since the cutting blade cuts concrete, etc. while being rotated, the guide rail must be installed so as to be strongly fixed in order to support the cutting blade.

As described above, the conventional wall saw performs cutting while moving on the set path along the guide rail. When it is necessary for the wall saw to perform cutting while moving on another path, therefore, the installed guide rail must be disassembled and then the guide rail must be fixedly installed on the other path, whereby efficiency in cutting work is very low. For example, a concrete wall is erected perpendicular to the ground, a guide rail is installed at the concrete wall in a direction parallel to the ground, and a cutting blade performs cutting work while moving along the guide rail in the horizontal direction. When it is necessary to perform cutting in a direction perpendicular to the ground in this state, the guide rail installed in the horizontal direction is disassembled, the guide rail is installed in the vertical direction, and the guide rail is fixed. As a result, efficiency in cutting work is very low.

In addition, even though the cutting work is performed only in the horizontal direction, it is not possible to infinitely extend the length of the guide rail. For this reason, the guide rail is disassembled, moved, and is fixedly installed in order to continuously perform the cutting work in the horizontal direction. As a result, overload of a worker is great due to unnecessary work other than the cutting work and time consumption. That is, when the cutting direction or the cutting angle is changed, it is necessary to disassemble the guide rail and to install the guide rail again, whereby overload of the worker is great due to unnecessary work other than the cutting work.

Furthermore, in the conventional wall cutting machine, the guide rail is implemented only in a straight shape. Consequently, it is possible to perform only straight cutting work, and curved or circular cutting using the conventional wall cutting machine is impossible.

In particular, is it impossible for the conventional wall cutting machine to perform cutting work while moving in a curved direction or in a circular direction.

For these reasons, the present invention proposes a cutting machine capable of solving the problems with the conventional wall cutting machine.

### DISCLOSURE

### Technical Problem

It is an object of the present invention to provide a cutting machine for cutting a wall.

Objects of the present invention are not limited to the aforementioned objects, and other unmentioned objects will be clearly understood by a person having ordinary skill in the art to which the present invention pertains based on the following description.

### Technical Solution

A cutting machine for cutting a wall of a structure supported on the ground to achieve the object includes a main frame, a first front wheel and a second front wheel located respectively at opposite sides of the front of the main frame, a rear wheel located at the rear of the main frame, a cutting frame having one side fixed to the vicinity of the front of the main frame, a cutting blade having a cutting shaft located in the vicinity of the other side of the cutting frame, the cutting blade being fitted on one side of the cutting shaft, the cutting blade being configured to cut the structure, a rotary motor fixed to the one side of the cutting frame, the rotary motor being configured to rotate the cutting blade, an auxiliary frame coupled to the cutting frame by hinge coupling, a front wheel axle connected to the main frame and the first front wheel or the second front wheel therebetween, and a height adjustment portion connected to the front wheel axle, the height adjustment portion being configured to adjust the angle of the front wheel axle to thus adjust the height of one side of the main frame to which the front wheel axle is connected, wherein the auxiliary frame includes an angle adjustment portion configured to adjust the cutting angle of the cutting blade such that the cutting blade is turned in a direction parallel to the wall of the structure and then the cutting blade is turned in a direction perpendicular to the wall of the structure in order to cut the wall of the structure.

On the assumption that the advancing direction of the cutting machine is a direction toward the front of the cutting frame, the other side of the cutting frame may correspond to the front of the cutting frame, and the cutting blade may be configured to cut the structure while being rotated in a direction parallel to the ground by the rotary motor.

The height adjustment portion may adjust the height of the main frame such that the one side and the other side of the main frame have the same height.

The cutting machine may further include a cutting depth adjustment portion configured to adjust the front cutting depth of the cutting blade and an upward-downward height adjustment portion configured to adjust the vertical height of the cutting frame with respect to the ground. The angle adjustment portion may be configured to maintain the angle such that the cutting blade advances forwards while being maintained at a constant height when the cutting blade enters the structure to cut the structure while being rotated by the rotary motor under control of the cutting depth adjustment portion.

The cutting machine may further include a fixing portion configured to fix the cutting frame to the cutting machine and two cylindrical frames and two quadrangular pillar frames fixedly installed at one side of the fixing portion, wherein a cylindrical bearing may be provided at each of the two cylindrical frames, the cutting frame may be connected to the auxiliary frame, the auxiliary frame being connected to the two cylindrical frames, and the upward-downward height adjustment portion may be configured to adjust the cylindrical bearing in order to adjust the vertical height of the cutting frame.

The cutting machine may further include a power motor configured to provide power to the rear wheel and a reducer connected to the power motor and the rear wheel therebetween, the reducer being configured to control driving of the cutting machine. The cutting machine may further include a driving direction adjustment portion connected to the rear wheel, the driving direction adjustment portion being configured to rotate the rear wheel such that the cutting machine is movable in a curved direction or in a circular direction, wherein the first front wheel may be located farther forwards than the second front wheel by a predetermined distance or more.

### Advantageous Effects

According to an embodiment of the present invention, a cutting machine (100) is capable of adjusting the height of a main frame (110) even when the ground is not even, whereby it is possible to maintain a cutting blade (130) horizontal, and therefore it is possible to improve cutting performance of the cutting machine.

According to an embodiment of the present invention, the cutting machine (100) includes an upward-downward adjustment portion, whereby it is possible to adjust the vertical height of a cutting frame, whereby it is possible to adjust the cutting height. In addition, the cutting machine (100) includes a cutting depth adjustment portion (165), whereby it is possible to change the cutting depth under control of the cutting depth adjustment portion (165).

According to an embodiment of the present invention, the cutting machine (100) includes an angle adjustment portion (138), whereby it is possible to adjust the angle of the cutting blade (130) and to maintain a specific angle of the cutting blade (130), and therefore it is possible to maintain tension of the cutting blade (130) such that the cutting blade does not droop in a downward direction.

Effects obtainable from the present invention are not limited by the above mentioned effects, and other unmentioned effects will be clearly understood by a person having ordinary skill in the art to which the present invention pertains based on the following description.

### DESCRIPTION OF DRAWINGS

FIG. 1 is a view showing a conventional wall cutting machine.

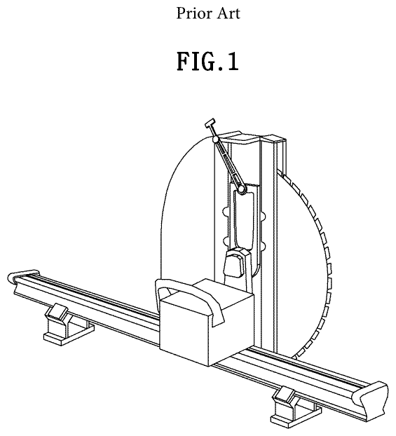

FIG. 2 is a plan view illustrating a cutting machine according to an embodiment of the present invention.

FIG. 3 is a view illustrating the structure of a cutting frame 120 for performing cutting work according to the present invention.

FIG. 4 is a view illustrating the structure of the cutting frame 120 for describing the cutting work according to the present invention.

FIG. 5 is a view illustrating the structure of the cutting machine 100 for adjusting the cutting height.

FIG. 6 is an illustrative view for describing adjustment of the angle of a main frame 110 of the cutting machine 100 according to the present invention.

FIG. 7 is a view illustrating the structure of a rear wheel 160 of the cutting machine 100 according to the present invention.

### BEST MODE

Hereinafter, preferred embodiments of the present invention will be described in detail with reference to the accompanying drawings. The detailed description disclosed hereinafter together with the accompanying drawings shows exemplary embodiments of the present invention and does not reveal a unique embodiment by which the present invention can be implemented. The following detailed description includes specific details in order to provide complete understanding of the present invention. However, those skilled in the art will appreciate that the present invention can be implemented without such specific details.

The detailed description of the present invention, which will follow, illustrates a specific embodiment by which the present invention can be implemented and refers to the accompanying drawings. These embodiments are described in detail such that those skilled in the art are capable of implementing the present invention. It should be understood that various embodiments of the present invention are different from each other but are not necessarily mutually exclusive. For example, a specific shape, structure, and characteristic of an embodiment described herein may be implemented as another embodiment without departing from the sprit and scope of the present invention. In addition, it should be understood that the position or disposition of individual elements in each disclosed embodiment may be changed without departing from the sprit and scope of the present invention. Consequently, the detailed description, which will follow, is not restrictive, and the scope of the present invention is limited by the appended claims and all equivalents thereto as long as the present invention is appropriately described. In the drawings, similar reference numerals indicate the same or similar functions in several aspects.

In some cases, in order to avoid the concept of the present invention being ambiguous, a well-known structure and apparatus may be omitted, or each structure and apparatus will be shown in the form of a block diagram including core functions thereof. In addition, the same elements are denoted by the same reference numerals throughout this specification.

Hereinafter, embodiments of the present invention will be described in detail with reference to the accompanying drawings such that a person having ordinary skill in the art to which the present invention pertains can easily implement the present invention.

In the present invention, the direction in which a cutting machine according to the present invention will be defined as a direction toward the front and the opposite direction will be defined as a direction toward the rear for ease of understanding.

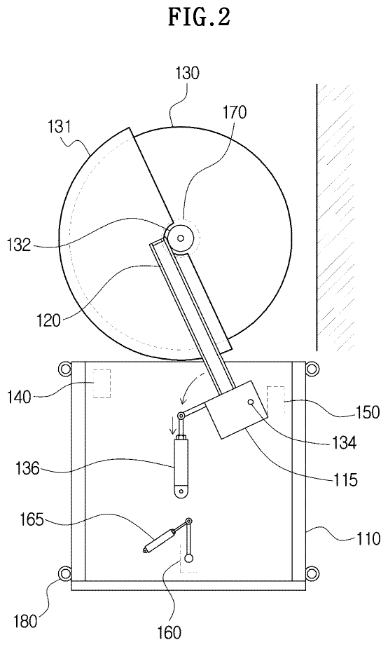

FIG. 2 is a plan view illustrating a cutting machine 100 according to an embodiment of the present invention.

Referring to FIG. 2, the cutting machine 100 according to the present invention is not a floor cutting machine but an intelligent cutting machine, e.g. a so-called wall saw. The cutting machine 100 according to the present invention may include a main frame 110, a cutting frame 120, a cutting blade 130, a cutting blade cover 131, a first front wheel 140, a second front wheel 150, a rear wheel 160, a driving direction adjustment portion 165, a rotary motor 170, and a lifting ring 180. In the present invention, the cutting machine is configured to have a structure in which the cutting machine includes the cutting frame 120, in addition to the main frame 110, such that the cutting blade 130 is movable independently of the main frame 110.

The main frame 110 may support equipment necessary for the cutting machine 100 to perform cutting, such as a power engine and a motor. That is, the equipment may be directly or indirectly located at an upper end of the main frame 110.

The cutting machine 100 shown in FIG. 2 may be a three-wheel drive cutting machine. In the present invention, “three-wheel” means a system in which engine power is simultaneously transmitted to three wheels or that three wheels are provided. In the present invention, the cutting machine 100 includes three wheels 140, 150, and 160, and power may be transmitted to the rear wheel 160. In FIG. 2, the cutting machine 100 is shown as including three wheels by way of example; however, two or more front wheels may be provided.

The main frame 110 is a basic frame configured to support the cutting machine 100. The plurality of front wheels (e.g. the two front wheels (the first front wheel 140 and the second front wheel 150) may be provided in the vicinity of the front (e.g. opposite sides of the front or opposite ends of the front) of the main frame 110. The rear wheel 160 is provided in the vicinity of the rear (e.g. the vicinity of the middle of the rear) of the main frame 100. Here, the diameter of each of the first front wheel 140 and the second front wheel 150 may be less than the diameter of the rear wheel 160.

The cutting machine 100 configured such that power is transmitted to the rear wheel 160 may further include another rear wheel such that four-wheel drive is also possible. In the present invention, the “four-wheel” means the system in which engine power is simultaneously transmitted to four wheels or that four wheels are provided. Each of the front wheels 140 and 150 may be connected to a front wheel axle 142. The driving direction adjustment portion 165, which is connected to the rear wheel 160 and which is configured to adjust the driving direction of the cutting machine 100, may be hydraulically or electrically operated. The details thereof will be described below.

The first front wheel 140 may be located farther forwards than the second front wheel 150 within a predetermined range. The reason for this is that, since the cutting blade 130 is located higher in front of the main frame 110, an angle adjustment portion 138 maintains the angle of the cutting frame 120 but, since load is applied to the cutting blade 130 during cutting, whereby a front portion thereof is pushed, it is necessary to dispose one of the front wheels so as to be located farther forwards than the other front wheel in order to support the cutting blade.

Next, the cutting machine 100 according to the present invention may include the cutting frame 120. The cutting frame 120 is configured such that one side of the cutting frame 120 is fixed to the main frame 110. For example, as shown in FIG. 2, one side of the cutting frame 120 may be fixed to the vicinity of the front of the main frame 110 by a fixing portion 115. The fixing portion 115 may be fixed to the main frame, etc. by a center bolt 134, etc. The rotary motor 170 may be attached to the other side of the cutting frame 120. The rotary motor 170 may be supported by the cutting frame 120 and may provide rotary power to rotate the cutting blade 130. A cutting shaft 132 is located in the vicinity of the other side of the cutting frame 120. The cutting blade 130 may be fitted on each end of the cutting shaft, or the cutting blade 130 may be fitted on one end of the cutting shaft. In FIG. 2, the cutting blade 130 is shown as being fitted on one end of the cutting shaft 132 by way of example.

In the state in which one side of the cutting frame 120 is fixed, one cutting blade 130 may be located in the vicinity of the other side of the cutting frame, or two cutting blades may be provided at opposite sides of the cutting shaft 132. The cutting blade cover 131 is configured to cover at least a part of the cutting blade 130.

The lifting ring 180 is a ring installed so as to connect a cable rope to the cutting machine 100 when the cutting machine is lifted. A total of four lifting rings may be provided at opposite ends of the front and opposite ends of the rear of the main frame 110. However, the number of the lifting rings 180 is not limited to 4.

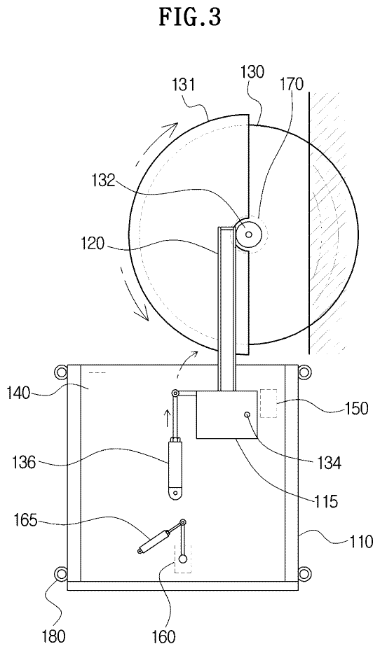

FIG. 3 is a view illustrating the structure of the cutting frame 120 for performing cutting work according to the present invention.

Referring to FIG. 3, the cutting shaft 132 is provided at the other side (e.g. in the vicinity of the end of the other side), and the cutting blade 130 is fitted on the cutting shaft 132. In order to cut a wall (concrete, etc.) shown in FIG. 3, the rotary motor 170 rotates the cutting blade 130. The cutting blade 130 cuts the wall while being rotated. At this time, one side of the cutting frame 120 is fixed, and the fixing portion 115 is fixed to the main frame 110 by the center bolt 134. A cutting depth adjustment portion 136 connected to the fixing portion 115 is configured to adjust the cutting depth of the cutting blade 130. The cutting depth adjustment portion 136 may be a hydraulic or electric means (as an example, a hydraulic cylinder, a hydraulic motor, or an electric motor). The cutting machine 100 may adjust the cutting depth of the cutting blade 130 through the cutting depth adjustment portion 136.

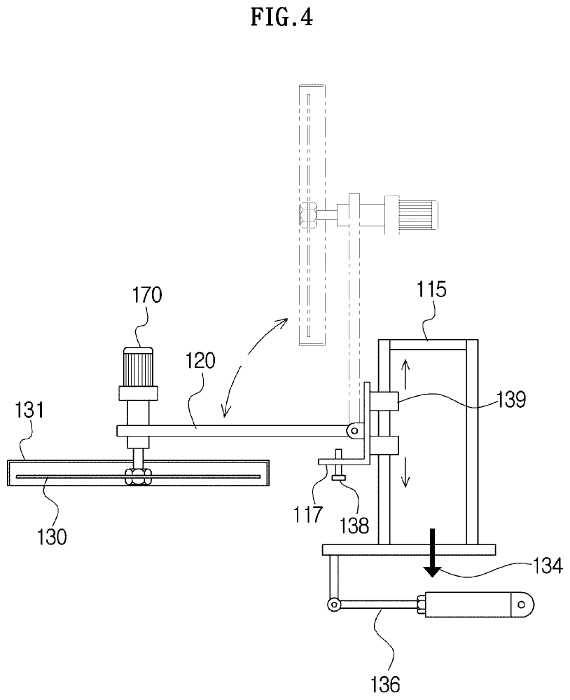

FIG. 4 is a view illustrating the structure of the cutting frame 120 for describing the cutting work according to the present invention.

FIG. 4 shows the fixing portion 115 shown in FIG. 3 in detail. A plurality of bearings 139 (two bearings are shown in FIG. 4 by way of example) is provided at one side of the fixing portion 115 corresponding to a shaft perpendicular to the ground. An upward-downward adjustment portion (not shown) enables the cutting frame 120 to move upwards and downwards in a direction perpendicular to the ground. The upward-downward adjustment portion may be implemented by a hydraulic cylinder or an electric motor. The upward-downward adjustment portion enables the cutting frame 120 to move upwards and downwards depending on the height of the wall through the plurality of bearings 139 in order to adjust the cutting height. For example, when the cutting height is increased or decreased in a vertical direction, the upward-downward adjustment portion may adjust the vertical height of the cutting frame through the bearings 139. It is preferable to provide two bearings 139 in order to achieve stability and robustness, although one bearing may be provided.

The cutting frame 120 may be connected to an auxiliary frame 117. At this time, the cutting frame 120 may be connected to the auxiliary frame 117 by hinge coupling, etc. The auxiliary frame 117 may be supported by two cylindrical frames 118. The auxiliary frame 117 is provided with an angle adjustment portion 138 (e.g. an angle adjustment bolt), and the angle adjustment portion 138 adjusts the angle of the cutting frame 120 to thus adjust the cutting angle of the cutting blade 130. In addition to adjustment of the angle of the cutting blade 120, the angle adjustment portion 138 maintains the cutting height of the cutting blade 130 as the result of the angle adjustment bolt being fixed at a specific angle. That is, the angle adjustment portion 138 enables the cutting blade 130 to cut the wall while being maintained in a horizontal direction without being bent downwards when rotated in the horizontal direction.

The angle adjustment portion 138 provided at the auxiliary frame 117 adjusts the cutting angle of the cutting blade 130 such that the cutting blade is turned in a direction parallel to the wall of the structure and then the cutting blade is turned in a direction perpendicular to the wall of the structure in order to cut the wall of the structure. As described above, the cutting machine 100 may perform cutting not only in the horizontal direction but also in the vertical direction through the angle adjustment portion 138 provided at the auxiliary frame 117. When the cutting direction is changed from the horizontal direction to the vertical direction or from the vertical direction to the horizontal direction, as described above, the position of the rotary motor 170 is also changed. The rotary motor 170 is fixedly coupled to the cutting frame 120 by a bolt, etc. The bolt may be loosened, and the rotary motor 170 may be installed horizontally or vertically, whereby cutting may be performed in any of the horizontal direction and the vertical direction.

In the conventional wall cutting machine, in order to adjust the cutting angle, the fixedly installed guide rail is disassembled, the guide rail is installed and fixed at a desired angle, and then cutting work is performed. In the cutting machine 100 according to the present invention, however, the angle adjustment portion 138 adjusts the angle of the cutting frame 120, whereby it is possible to easily adjust the cutting angle, and therefore it is possible to considerably improve efficiency in cutting work. As shown in FIG. 4, the cutting frame 120 may be erected or laid down in a direction indicated by an arrow through adjustment of the angle adjustment portion 138.

The cutting depth adjustment portion 136 may be a hydraulic or electric means (as an example, a hydraulic cylinder, a hydraulic motor, or an electric motor). The cutting machine 100 may adjust the cutting depth of the cutting blade 130 through the cutting depth adjustment portion 136.

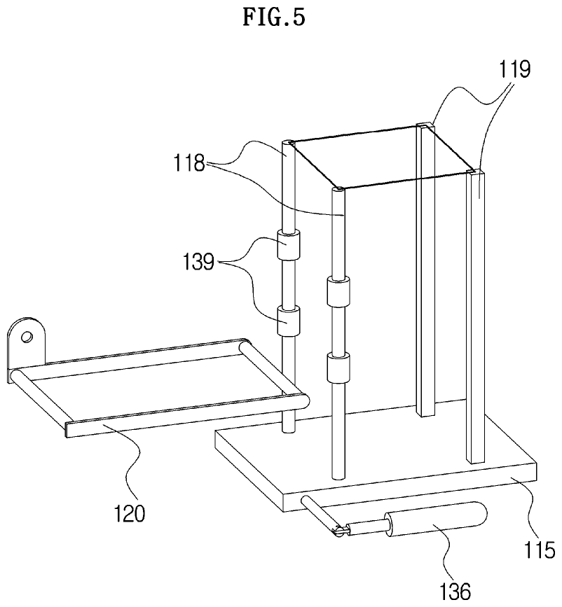

FIG. 5 is a view illustrating the structure of the cutting machine 100 for adjusting the cutting height.

Referring to FIG. 5, the fixing portion 115 may support two cylindrical frames 118 and two quadrangular pillar frames 119 in the vertical direction. The reason that all frames are not quadrangular pillar frames and two fames are provided as cylindrical frames 118 is that it is necessary to connect the bearings to the cylindrical frames. Here, the term “bearings” is used for convenience of description, and therefore any members configured to support the cylindrical frames while sliding may be used.

As shown in FIG. 5, as an example, a plurality of bearings 139 is provided at each of the two cylindrical frames 118. The cutting frame 120 is connected to the plurality of bearings 139 such that the vertical height of the cutting frame 120 can be adjusted by the plurality of bearings 139. The reason that parts to which the cutting frame 120 is connected are cylinders is that it is necessary to install the plurality of bearings 139 to the cylinders.

Each of the two quadrangular pillar frames 119 shown in FIG. 5 is formed in a quadrangular shape for stable fixing and support. The two quadrangular pillar frames 119 and the two cylindrical frames 118 are connected to each other so as to be supported on the fixing portion 115.

Although not shown in FIG. 5, the upward-downward adjustment portion may enable the cutting frame 120 to move upwards and downwards depending on the height of the wall through the plurality of bearings 139 in order to adjust the cutting height.

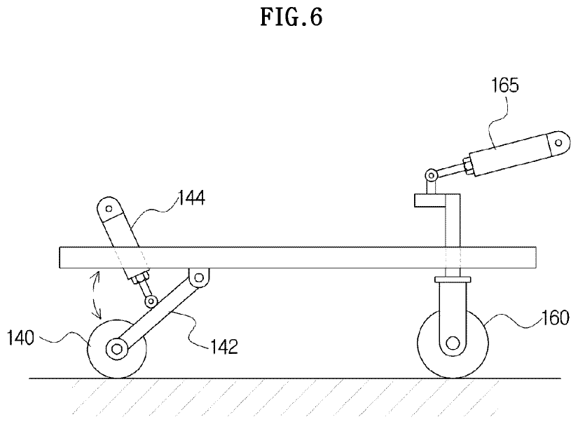

FIG. 6 is an illustrative view for describing adjustment of the angle of the main frame 110 of the cutting machine 100 according to the present invention.

Referring to FIG. 6, as previously described, the first front wheel 140 is located farther forwards than the second front wheel 150 within a predetermined range. The first front wheel 140 is connected to one side of the front (e.g. the left side of the front) of the main frame 110, and the second front wheel 150 is connected to the other side of the front (e.g. the right side of the front) of the main frame 110. The floor, on which the first front wheel 140 and the second front wheel 150 are supported, is not even depending on work environment. If the floor is not even, one side and the other side of the front of the main frame 110 are not level with each other, whereby the main frame 110 may be inclined to any one of the opposite sides. In this case, the cutting machine 100 is inclined, whereby the cutting blade 130 is not horizontally maintained.

In order to solve this problem, the cutting machine 100 according to the present invention may include a height adjustment portion configured to adjust the height of one side of the front of the main frame 110 to which the first front wheel 140 is connected. The height adjustment portion 144 is connected to the front wheel axle 142 connected to the main frame 110 and the first front wheel 140 therebetween to adjust the angle of the front wheel axle 142 (to adjust the angle of the front wheel axle 142 with respect to the horizontal plane), whereby it is possible to adjust the height of one side of the main frame 110 to which the front wheel axle 142 is connected.

At this time, the height adjustment portion 144 may be implemented by any of various means, such as a hydraulic or electric means (a hydraulic cylinder, an electric motor, etc.). A floor cutting machine cuts the floor in the direction perpendicular to the floor. Even though the heights of opposite sides of the main frame 110 are different from each other, therefore, there is no problem in cutting the floor. In the cutting machine 100 according to the present invention, however, the cutting blade 130 is not maintained horizontal if the heights of opposite sides of the main frame 110 are different from each other, whereby cutting performance is remarkably reduced. The height adjustment portion 144 according to the present invention enables the cutting machine 100 to be maintained horizontal, whereby it is possible to maintain cutting performance of the cutting machine.

As shown in FIG. 6, the driving direction adjustment portion 165 is provided at the rear wheel 160. The driving direction adjustment portion 165 may adjust the driving direction of the cutting machine 100 such that the cutting machine can drive in all directions. The cutting machine 100 may perform curved driving or circular driving as well as straight driving according to the driving direction adjustment function of the driving direction adjustment portion 165. The cutting machine 100 may perform cutting while driving.

The rear wheel 160 is rotatable by the driving direction adjustment portion 165, whereby it is possible to adjust the driving direction of the cutting machine 100, including the advancing direction of the cutting machine. Most conventional floor cutting machines are manual cutting machines, the driving direction of each of which is not adjustable and each of which is configured to be moved in a state of being held by a worker. Rotation of the rear wheel 160 of the cutting machine 100 shown in FIG. 6 can be manipulated by the worker. That is, the worker may adjust rotation and the driving direction of the rear wheel 160 using a controller, a remote controller, etc., whereby it is possible to manipulate movement of the cutting machine 100. The driving direction adjustment portion 165 may be a hydraulic or electric means (e.g. a hydraulic driving direction adjustment cylinder or an electric motor). The rear wheel 160 is easily rotatable and can be rotated 360 degrees. Consequently, the cutting machine 100 according to the present invention is capable of performing circular cutting and curved cutting.

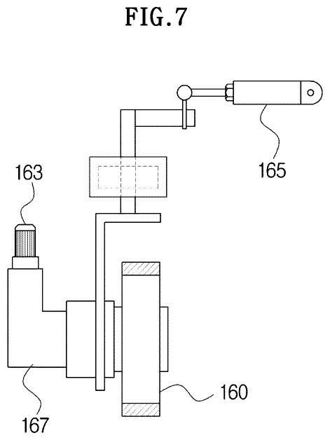

FIG. 7 is a view illustrating the structure of the rear wheel 160 of the cutting machine 100 according to the present invention.

Referring to FIG. 7, the cutting machine 100 may include a power motor 163 and a reducer 167 configured to provide power to the rear wheel 160. The power motor 163 and the reducer 167, which are equipment that supports movement of the cutting machine 100, may be controlled by the worker or a wireless controller.

The reducer 167 is located between the power motor (hydraulic motor or electric motor) 160 and the rear wheel 160. The rear wheel 160, which is a powered wheel, may receive driving force from the power motor 160. When the power motor 163 makes one turn, the rear wheel 160 also makes one turn. For example, when the diameter of the rear wheel 160 is about 15 cm, the cutting machine 100 moves about 50 cm (3.14×15).

In order for the cutting machine 100 to cut a reinforcing bar or concrete, however, the cutting machine 100 must very slowly move, although the power motor 163 is driven at a high speed. In many cases, the cutting machine 100 must not move 20 cm or more per minute. When the power motor 163 and the rear wheel 160 are directly connected to each other, therefore, accuracy and safety of the cutting machine 100 may be reduced. Furthermore, since the power motor 163 can generate meaningful power when the power motor makes at least 15 to 20 turns per minute, a problem may occur when the power motor 163 and the rear wheel 160 are directly connected to each other, as shown in FIG. 7.

Particularly, in the conventional floor cutting machine, when the floor cutting machine seems to advance too far after the power motor 163 is driven, the worker manually controls movement of the floor cutting machine. However, this requires much effort on the part of the worker and precise control is impossible. In the cutting machine 100 according to the present invention, the reducer 167 is connected to the power motor 163 and the rear wheel 160 therebetween. The cutting machine 100 according to the present invention may include a wireless controller (e.g. a wireless remote controller) configured to wirelessly control the power motor 163 and the reducer 167. Even when the engine is operated at a high speed by the power motor 163, therefore, the cutting machine 100 is slowly moved by the reducer 167 during cutting, whereby it is possible to precisely control movement of the cutting machine.

That is, in the cutting machine 100 according to the present invention, the power motor 163 and the rear wheel 160 are connected to each other via the reducer 167. The engine may be driven at a high speed by the power motor 163 (or may be driven at a high output), and the reducer 167 may perform control such that the cutting machine 100 slowly moves forwards. For example, when the reduction ratio of the reducer 167 is set to 30:1, the rear wheel 160 makes one turn even when the power motor 163 makes 30 turns, whereby it is possible to precisely control movement of the cutting machine 100. The reducer 167 may by manually controlled by the worker, or may be controlled by the wireless controller.

In addition, when the cutting machine 100 according to the present invention performs cutting work on a ramp, the cutting work on the ramp may be easily performed using the reducer 167. Since the power motor 163 has no brake function, the cutting machine 100 may move downwards along the ramp even without operation of the power motor 163. However, the reducer 167 may also serve as a brake of the cutting machine 100 on the ramp.

When the rear wheel 160 is rotatable, whereby the driving direction of the cutting machine is adjusted, and the reducer 167 is also provided, movement of the cutting machine 100 is precisely controlled and the brake function is operated on the ramp, whereby it is possible to greatly improve performance of the cutting machine 100. Here, as an example, the rear wheel 160 may be a urethane rear wheel.

Most conventional cutting machines are configured to have four wheels. In the three-wheel drive cutting machine described above, however, it is possible to easily and rapidly change the driving direction of the cutting machine in a small space.

As is apparent from the above description, the cutting machine 100 according to the present invention is capable of performing cutting work while moving in a curve or a circle, whereby it is possible to perform cutting in various directions. In addition, even when moving straight, the cutting machine 100 according to the present invention is capable of performing cutting work without installation of a separate guide rail, whereby it is possible to increase the work speed and to reduce unnecessary work of workers.

As is apparent from the above description, the cutting machine 100 according to the present invention is capable of adjusting the height of the main frame 110 even when the ground is not even, whereby it is possible to maintain the cutting blade 130 horizontal, and therefore it is possible to improve cutting performance of the cutting machine.

As is apparent from the above description, the cutting machine 100 according to the present invention includes the upward-downward adjustment portion, whereby it is possible to adjust the vertical height of the cutting frame, whereby it is possible to adjust the cutting height, and includes the cutting depth adjustment portion 165, whereby it is possible to change the cutting depth under control of the cutting depth adjustment portion 165.

As is apparent from the above description, the cutting machine 100 according to the present invention includes the angle adjustment portion 138, whereby it is possible to adjust the angle of the cutting blade 130 and to maintain a specific angle of the cutting blade 130, and therefore it is possible to maintain tension of the cutting blade 130 such that the cutting blade does not droop in a downward direction.

The embodiments described above are predetermined combinations of elements and features of the present invention. Each element or feature must be considered to be optional unless explicitly mentioned otherwise. Each element or feature may be implemented in a state of not being combined with another element or feature. In addition, some elements and/or features may be combined to constitute an embodiment of the present invention. The sequence of operations described in the embodiments of the present invention may be changed. Some elements or features in a certain embodiment may be included in another embodiment, or may be replaced with corresponding elements or features in another embodiment. It is obvious that claims having no explicit citation relationship may be combined to constitute an embodiment or may be included as a new claim by amendment after application.

Those skilled in the art will appreciate that the present invention may be embodied in other specific forms than those set forth herein without departing from essential characteristics of the present invention. The above description is therefore to be construed in all aspects as illustrative and not restrictive. The scope of the invention should be determined by reasonable interpretation of the appended claims and all changes coming within the equivalency range of the invention are intended to be within the scope of the invention.

### DESCRIPTION OF REFERENCE NUMERALS

Cutting machine (100)
Main frame (110)
Fixing portion (115)
Auxiliary frame (117)
Two cylindrical frames (118)
Two quadrangular pillar frames (119)
Cutting frame (120)
Cutting blade (130)
Cutting blade cover (131)
Cutting shaft (132)
Cutting depth adjustment portion (136)
Angle adjustment portion (138)
Plurality of bearings (139)
First front wheel (140)
Front wheel axle (142)
Height adjustment portion (144)
Second front wheel (150)
Rear wheel (160)
Power motor (163)
Driving direction adjustment portion (165)
Reducer (167)
Rotary motor (170)
Lifting ring (180)

### INDUSTRIAL APPLICABILITY

An intelligent cutting machine for cutting a wall according to the present invention is industrially applicable to the structure demolition industry, etc.

1. A cutting machine for cutting a wall of a structure supported on a ground, the cutting machine comprising:
a main frame;
a first front wheel and a second front wheel located respectively at opposite sides of a front of the main frame;
a rear wheel located at a rear of the main frame;
a cutting frame having one side fixed to a vicinity of the front of the main frame;
a cutting blade having a cutting shaft located in a vicinity of the other side of the cutting frame, the cutting blade being fitted on one side of the cutting shaft, the cutting blade being configured to cut the structure;
a rotary motor fixed to the one side of the cutting frame, the rotary motor being configured to rotate the cutting blade;
an auxiliary frame coupled to the cutting frame by hinge coupling;
a front wheel axle connected to the main frame and the first front wheel or the second front wheel therebetween; and
a height adjustment portion connected to the front wheel axle, the height adjustment portion being configured to adjust an angle of the front wheel axle to thus adjust a height of one side of the main frame to which the front wheel axle is connected, wherein
the auxiliary frame comprises an angle adjustment portion configured to adjust a cutting angle of the cutting blade such that the cutting blade is turned in a direction parallel to the wall of the structure and then the cutting blade is turned in a direction perpendicular to the wall of the structure in order to cut the wall of the structure.

2. The cutting machine according to claim 1, wherein
on the assumption that an advancing direction of the cutting machine is a direction toward a front of the cutting frame, the other side of the cutting frame corresponds to the front of the cutting frame, and
the cutting blade is configured to cut the structure while being rotated in a direction parallel to the ground by the rotary motor.

3. The cutting machine according to claim 1, wherein the height adjustment portion adjusts the height of the main frame such that the one side and the other side of the main frame have the same height.

4. The cutting machine according to claim 1, further comprising:
a cutting depth adjustment portion configured to adjust a front cutting depth of the cutting blade; and
an upward-downward height adjustment portion configured to adjust a vertical height of the cutting frame with respect to the ground.

5. The cutting machine according to claim 4, wherein the angle adjustment portion is configured to maintain the angle such that the cutting blade advances forwards while being maintained at a constant height when the cutting blade enters the structure to cut the structure while being rotated by the rotary motor under control of the cutting depth adjustment portion.

6. The cutting machine according to claim 1, further comprising:
a fixing portion configured to fix the cutting frame to the cutting machine; and
two cylindrical frames and two quadrangular pillar frames fixedly installed at one side of the fixing portion, wherein
a cylindrical bearing is provided at each of the two cylindrical frames,
the cutting frame is connected to the auxiliary frame, the auxiliary frame being connected to the two cylindrical frames, and
the upward-downward height adjustment portion is configured to adjust the cylindrical bearing in order to adjust the vertical height of the cutting frame.

7. The cutting machine according to claim 1, further comprising:
a power motor configured to provide power to the rear wheel; and
a reducer connected to the power motor and the rear wheel therebetween, the reducer being configured to control driving of the cutting machine.

8. The cutting machine according to claim 1, further comprising:
a driving direction adjustment portion connected to the rear wheel, the driving direction adjustment portion being configured to rotate the rear wheel such that the cutting machine is movable in a curved direction or in a circular direction, wherein
the first front wheel is located farther forwards than the second front wheel by a predetermined distance or more.

9. The cutting machine according to claim 7, further comprising:
a driving direction adjustment portion connected to the rear wheel, the driving direction adjustment portion being configured to rotate the rear wheel such that the cutting machine is movable in a curved direction or in a circular direction, wherein
the first front wheel is located farther forwards than the second front wheel by a predetermined distance or more.
